(19) United States
(12) Patent Application Publication
(10) Pub. No.: US 2026/0091702 A1
(43) Pub. Date: Apr. 2, 2026

(54) ADAPTIVE CHARGING SCHEDULING

(71) Applicant: Volvo Car Corporation, Göteborg (SE)

(72) Inventors: Adina Maria SOROSTINEAN, Gothenburg (SE); Madhan Kumar BALASUBRAMANI, Västra Frölunda (SE); Meng LIU, Gothenburg (SE); Sayali KHERATKAR, Göteborg (SE); Megha BENNUR, Göteborg (SE); Karthikeyan RAVINDRAN, Göteborg (SE)

(73) Assignee: Volvo Car Corporation, Göteborg (SE)

(21) Appl. No.: 18/899,150

(22) Filed: Sep. 27, 2024

(51) Int. Cl. B60L 53/68; B60L 58/12

(52) U.S. Cl. CPC B60L 53/68; B60L 58/12; B60L 2240/72

(57) ABSTRACT

A system comprises: a battery management system; a global positioning system; and a processor. The processor storing instructions in non-transitory memory that, when executed, causes the processor to: receive information of a first charging reservation plan of a vehicle; monitor a location of the vehicle in real-time and determine an expected time-of-arrival at a charging location; determine a state-of-charge of a battery pack of vehicle; predict whether the vehicle would arrive at the charging location around a charging session start time with predefined state-of-charge and charge the vehicle as per the first charging reservation plan; determine a cause for a delay in arriving at the charging location; calculate an urgency score based on the cause for the delay; and modify the first charging reservation plan to a second charging reservation plan and reserve another charging session in compliance with an actual time-of-arrival to start charging from the predefined state-of-charge.

### FIELD OF THE INVENTION

The present disclosure relates generally to a charging reservation system. More specifically, the present disclosure relates to a system that adaptively modifies the reserved charging session based on actual time-of-arrival.

### BACKGROUND

In a conventional reservation system, if estimated arrival time and the actual arrival time are significantly different, the re-reservation or reservation is canceled. However, there is an unfair feeling that reservation and re-reservation are canceled due to the arrival-time delay despite the early reservation. On the other hand, if the reservation system can flexibly change the reservation schedule according to the arrival time, not re-reservation or cancellation, the charger of the charging station can be used efficiently, and unfairness does not occur.

Therefore, there is a long-felt need for a system that adaptively modifies the reserved charging session based on actual time-of-arrival.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, methods, and/or apparatus are presented that describes a system that adaptively modifies the reserved charging session based on actual time-of-arrival.

In an aspect, a system is described. The system comprises: a battery management system; a global positioning system (GPS); and a processor. The processor storing instructions in non-transitory memory that, when executed, causes the processor to: receive first information of a first charging reservation plan of a vehicle with a first charging station; monitor, via the global positioning system, a current location of the vehicle in real-time and determine an expected time-of-arrival (ETA) at a charging location; determine, via the battery management system, a state-of-charge of a battery pack of the vehicle; predict whether the vehicle would arrive at the charging location around a charging session start time with predefined state-of-charge and would charge the vehicle as per the first charging reservation plan; determine a cause for a delay in arriving at the charging location beyond the charging session start time; calculate an urgency score based on the cause for the delay; and modify the first charging reservation plan to a second charging reservation plan and reserve a second charging session with one of the first charging station and a second charging station in compliance with an actual time-of-arrival to charge the vehicle beginning from the predefined state-of-charge when the urgency score is greater than a threshold value.

In an aspect, a method is described. The method comprises: receiving first information of a first charging reservation plan of a vehicle with a first charging station; monitoring, via a global positioning system, a current location of the vehicle in real-time and determine an expected time-of-arrival (ETA) at a charging location; determining, via a battery management system, a state-of-charge of a battery pack of the vehicle; predicting whether the vehicle would arrive at the charging location around a charging session start time with predefined state-of-charge and would charge the vehicle as per the first charging reservation plan; determining a cause for a delay in arriving at the charging location beyond the charging session start time; calculating an urgency score based on the cause for the delay; and modifying the first charging reservation plan to a second charging reservation plan and reserve a second charging session with one of the first charging station and a second charging station in compliance with an actual time-of-arrival to charge the vehicle beginning from the predefined state-of-charge when the urgency score is greater than a threshold value.

In an aspect, a non-transitory computer readable storage medium is described. A non-transitory computer readable storage medium comprising a sequence of instructions which when executed by a processor causes: receiving first information of a first charging reservation plan of a vehicle with a first charging station; monitoring, via a global positioning system, a current location of the vehicle in real-time and determine an expected time-of-arrival (ETA) at a charging location; determining, via a battery management system, a state-of-charge of a battery pack of the vehicle; predicting whether the vehicle would arrive at the charging location around a charging session start time with predefined state-of-charge and would charge the vehicle as per the first charging reservation plan; determining a cause for a delay in arriving at the charging location beyond the charging session start time; calculating an urgency score based on the cause for the delay; and modifying the first charging reservation plan to a second charging reservation plan and reserve a second charging session with one of the first charging station and a second charging station in compliance with an actual time-of-arrival to charge the vehicle beginning from the predefined state-of-charge when the urgency score is greater than a threshold value.

In an aspect, a system is described. The system comprises: a processor storing instructions in non-transitory memory that, when executed, causes the processor to: determine a charging location and reserves a first charging schedule with a charging station at the charging location as per an actual plan; monitors an expected time-of-arrival (ETA) at the charging location and a state-of-charge of a battery pack of the vehicle in real-time; predict whether an operational plan deviates from the actual plan based on the expected time-of-arrival (ETA) and the state-of-charge; and modify the first charging schedule to a second charging schedule to comply with actual time-of-arrival and the state-of-charge.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system, according to one or more embodiments.

FIG. 2 illustrates a method, according to one or more embodiments.

FIG. 3 illustrates a non-transitory computer readable storage medium, according to one or more embodiments.

FIG. 4 illustrates a schematic diagram illustrating a technical idea of adaptive charging scheduling, according to one or more embodiments.

FIG. 5 illustrates a schematic diagram illustrating a technical idea of adaptive charging scheduling, according to one or more embodiments.

FIG. 6 illustrates a battery pack comprising an individual battery, according to one or more embodiments.

FIG. 7 illustrates a battery pack comprising a plurality of batteries, according to one or more embodiments.

FIG. 8 schematically shows a battery pack and a battery management system, according to one or more embodiments.

FIG. 9 illustrates a vehicle approaching for charging as per the first charging reservation plan, according to one or more embodiments.

FIG. 10 illustrates a vehicle approaching for charging as per the second charging reservation plan, according to one or more embodiments.

FIG. 11 illustrates a communication flow diagram between a system and a charge management reservation server, according to one or more embodiments.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

Embodiments may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

The following terms and phrases, unless otherwise indicated, shall have the following meanings.

As used herein, the term “first charging reservation plan” refers to a first charging session that is booked in advance for charging the vehicle. The first charging reservation plan ensures that a charging spot will be available when the vehicle arrives, reducing wait times and improving the overall charging experience. The first charging reservation plan may be booked in advance considering the expected time-of-arrival of the vehicle at the charging location.

As used herein, the term “second charging reservation plan” refers to a second charging session that is modified from the first charging session. The second charging session is updated from the first charging session considering a delay in the arrival of the vehicle at the charging location. The second charging reservation plan is updated from the first charging reservation plan in order to modify the charging session per the actual time-of-arrival of the vehicle. The second charging reservation plan ensures that a charging spot will be available when the vehicle actually arrives, reducing wait times and improving the overall charging experience. The second charging reservation pan may be generated in advance considering the actual time of arrival of the vehicle at the charging location.

As used herein, the term “Battery Management System (BMS)” refers to an electronic system designed to monitor and manage the performance, safety, and reliability of a rechargeable battery. The BMS ensures that the battery operates within its optimal parameters, thereby maximizing its lifespan and efficiency. The term “battery management system (BMS)” also refers to a system that is used to monitor and control power storage systems, assure health of battery cells, and deliver power to vehicle systems.

As used herein, the term “battery pack” refers to a collection of individual battery cells or modules electrically connected to each other to achieve a desired voltage, capacity, and performance. The battery pack may typically be in association with additional components such as a battery management system (BMS), connectors, and sometimes cooling systems. The primary purpose of a battery pack is to provide a reliable and compact energy storage solution suitable for specific applications.

As used herein, the term “Global Positioning System (GPS)” refers to a system that uses a network of satellites to determine the precise location, speed, and direction of the vehicle. GPS provides real-time navigational data and is commonly integrated into car navigation systems, smartphones, and other devices used for driving. There are a variety of satellite networks for positioning systems around the world.

As used herein, the term “current location” refers to the precise geographical point where an individual, vehicle, or device is situated at a specific moment in time. This position is typically represented by coordinates (latitude and longitude) and can be determined using various technologies, most commonly through a GPS (Global Positioning System) in the US. The current location may also be determined using cellular networks, Wi-Fi Positioning, Bluetooth and Beacons, Inertial Navigation System (INS).

As used herein, the term “Expected Time-of-Arrival (ETA)” refers to the estimated time at which a vehicle is expected to reach a specific destination or checkpoint. Expected Time-of-Arrival (ETA) is calculated based on various factors such as distance and route, speed and mode of transport, and real-time data. The expected time-of-arrival (ETA) is calculated using different system such as navigation systems, logistics and fleet management, online maps and applications, predictive analytics, etc.

As used herein, the term “Actual Time-of-Arrival (ATA)” refers to the exact time when a vehicle reaches a specific destination or checkpoint. Unlike the Expected Time-of-Arrival (ETA), which is an estimate, ATA is the real-time arrival time observed or recorded at the destination. The actual time-of-arrival may be recorded using GPS tracking or manual entry.

As used herein, the term “state-of-charge (SoC)” refers to the level of charge of an electric battery relative to its capacity. The units of SoC are percentage points (0%=empty; 100%=full). An alternative form of the same measure is the depth of discharge (DoD), the inverse of SoC (100%=empty; 0%=full). SoC is normally used when discussing the current state of a battery in use, while DoD is most often seen when discussing the lifetime of the battery after repeated use.

As used herein, the term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is defined as the ratio of the maximum battery charge to its rated capacity. It is expressed in percentage form.

As used herein, the term “charging location” refers to a place or a locality at which the charging reservation is scheduled. The charging location refers to the place at which the charging of the vehicle is about to happen. The charging location may comprise a plurality of charging stations.

As used herein, the term “charging session start time” refers to the specific moment when a vehicle begins to receive electrical power from a charging station. This time is typically recorded and may be important for tracking charging habits, monitoring energy consumption, and managing billing or payment processes in charging networks.

As used herein, the term “charging session end time” refers to the specific moment when an electric vehicle (EV) completes its charging process and disconnects from the charging station. This timestamp is essential for various purposes, including billing, tracking charging habits, managing energy consumption, and ensuring efficient use of charging infrastructure.

As used herein, the term “predefined state-of-charge” refers to a specific level or percentage of battery capacity that is predetermined or set as a target for an electric vehicle (EV) to start charging during a charging session. This concept is essential for managing and optimizing the charging process, ensuring that the EV's battery is charged to a desired level based on operational needs or user preferences.

As used herein, the term “urgency score” refers to a numerical or qualitative assessment used to prioritize tasks, issues, or situations based on their level of urgency. This score helps individuals or teams to modify the first charging session to the second charging session to charge the vehicle in compliance with the actual time-of-arrival of the vehicle. The cause of the delay of the vehicle may be due to an urgency such as visiting a hospital. The urgency score for such causes may be high. In an embodiment, the cause of the delay of the vehicle may be due to a change in itinerary (such as visiting a mall for shopping). The urgency score for such causes may be low.

As used herein, the term “charging sequence” refers to a charging pattern defined by the connector based on the charging configuration parameters. The charging sequence may comprise a charging level for a predefined charging time segment. The charging sequence may also comprise a charging level for a predefined portion (e.g., healthy cells, degraded cells) of the battery pack. The charging level may comprise a regular charging, a fast charging, and a trickle charging.

As used herein, the term “charging specification” refers to the detailed requirements and characteristics that define how a device, typically an electric vehicle (EV) or a battery-powered system, should be charged. These specifications encompass various aspects such as voltage, current, power levels, connector types, and communication protocols. Further, the charging specification refers to a maximum amount of electrical energy that a battery pack or an electrical device can accept and store during the charging process. This capacity is typically measured in units such as ampere-hours (Ah) or milliampere-hours (mAh) for batteries, and it indicates the efficiency and capability of the battery pack to store energy.

As used herein, the term “charging duration” refers to the amount of time required to charge a battery pack to a desired level from a depleted state to its desired capacity. In an embodiment, the desired capacity may be the capacity required to jumpstart the recipient. In an embodiment, the desired capacity may be the full capacity. The charging duration depends on several factors, including: battery capacity (C), charging current (I), and C-rate.

As used herein, the term “charging temperature” refers to the temperature range within which a battery can be safely and efficiently charged. This range is crucial for maintaining the battery's performance, safety, and lifespan. Charging a battery outside its recommended temperature range can lead to several issues, such as reduced efficiency, decreased capacity, and potential safety hazards like overheating or thermal runaway.

As used herein, the term “itinerary information” refers to a detailed schedule of activities and events planned for a trip or event. The itinerary information comprises travel details such as vehicle ID, departure and arrival locations, departure and arrival times, intermediary waiting location, waiting time (halt time), number of occupants, estimated charge consumption, etc.

As used herein, the term “charging mode” refers to the specific method or protocol used to recharge the battery of an electric vehicle (EV). The mode chosen can affect the speed of charging, the type of charging equipment required, and the overall efficiency of the charging process. The types of charging modes include: Level 1 charging, level 2 charging, and level 3 charging. The types of charging modes include: trickle charging, fast charging, regular charging.

As used herein, the term “level 1 charging” refers to a charge that uses 120-207 Volts. Level 1 charging may be the slowest way to charge a battery of the vehicle.

As used herein, the term “level 2 charging” refers to a charge that uses 208-240 Volts.

As used herein, the term “level 3 charging” refers to a charge that uses 400-900 Volts Direct Current (DC). Level 3 charging is the fastest type of charging available.

As used herein, the term “maximum charging” or “optimally charging” as used refers to a maximum rate at which the charging is provided to the battery pack during the charging duration without damaging the battery pack.

As used herein, the term “trickle charging” refers to charging a battery pack continuously or periodically with a very small current. The trickle charge also refers to a continuous, slow charge applied to the battery pack.

As used herein, the term “fast charging” refers to charging a battery pack faster than regular charging.

As used herein, the term “regular charging” refers to charging a battery pack by supplying a standard charging voltage employed according to the capacity of the battery pack.

As used herein, the term “anticipated routing” refers to the planned or expected path that a vehicle or other moving entity will follow from its origin to its destination. The anticipated routing comprises travel details such as vehicle ID, departure and arrival locations, departure and arrival times, intermediary waiting locations, waiting time (halt time), etc.

As used herein, the term “travel path information” refers to details about the route or itinerary taken by a vehicle from a starting point to a destination. The travel path information comprises at least a start point, an end point, one or more intermediary points, a navigation route, a halt period, a traffic condition, an environmental weather condition, and a road condition.

As used herein, the term “driving behavior” refers to the actions, habits, and decisions made by drivers while operating vehicles on roads and highways. It encompasses a wide range of factors that influence how safely, efficiently, and responsibly individuals drive. The driving behavior may be calculated based on speed control, acceleration and deceleration, lane discipline, following distance, compliance with traffic laws, alertness and awareness, defensive driving, eco-driving practices.

As used herein, the term “intentional delay” refers to a deliberate act or decision to postpone or slow down a process, action, or response for a specific purpose or strategic reason.

As used herein, the term “unintentional delay” refers to a delay that occurs without deliberate intent or forethought, often due to unforeseen circumstances, factors beyond one's control, or accidental oversight.

As used herein, the term “electric vehicle (EV)” refers to an automobile, as defined in 49 Code of Federal Regulations (CFR) 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle, a battery electric vehicle (BEV), a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein the term “plug” refers to a component attached to an electrically-operated device, often via a cable.

As used herein, the term “heavy duty vehicle (HD Vehicle)” refers to any four- or more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4, 545 kg (10,000 pound) gross vehicle weight.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service, and of the emergency-reporting vehicle.

As used herein, the term “message structure” refers to a structure of a communication message when a query and fetch operation occurs. It comprises a payload and a header, where the payload includes the quantitative value of the information that is shared, and the header includes reference to the information being shared. The message structure acts as a superstructure to accommodate any sub protocol structure such as Advanced Message Queuing Protocol (AMQP), Message Queuing Telemetry Transport (MQTT), Zigbee, etc.

As used herein, a “Sensor” is a device that detects and measures physical properties from the surrounding environment and converts this information into electrical or digital signals that can be interpreted by either a human or a machine for further processing. Sensors play a crucial role in collecting data for various applications across industries. Sensors may be made of electronic, mechanical, chemical, or other engineering components. Most sensors are electronic (the data is converted into electronic data), but some are simpler, such as a glass thermometer, which presents visual data. Examples include sensors to measure temperature, pressure, humidity, proximity, light, acceleration, orientation, road conditions, traffic conditions, weather conditions, temperature, etc. In an embodiment, sensors may be removably or fixedly installed within the vehicle and may be disposed in various arrangements to provide information to the autonomous operation features. The sensors may include camera, temperature sensors, Infrared (IR) sensor, etc. Some of the sensors may actively or passively determine road conditions, traffic, weather, etc.

The term “vehicle” as used herein refers to a thing used for transporting people or goods. Automobiles, cars, trucks, buses, etc., are examples of vehicles.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

As used herein, the term “autonomous mode” refers to a vehicle operating mode which is independent and unsupervised.

As used herein, the term “autonomous communication” comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

As used herein, the term “communication protocol” refers to standardized communication between any two systems. An example of a communication protocol is the DSRC protocol. The DSRC protocol uses a specific frequency band (e.g., 5.9 GHZ) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the IEEE and SAE International.

As used herein, the term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Systems to communicate and interpret sensor information to identify such things as appropriate navigation paths, safe driving operations, obstacles, and relevant signage.

As used herein, the term “semi-autonomous vehicle” refers to vehicles that can operate for extended periods with little human input. A semi-autonomous vehicle cannot drive itself at all times but does automate some driving functions under ideal conditions like highway driving. A semi-autonomous vehicle may use “autopilot” features. In one embodiment, semi-autonomous vehicles may be able to keep in lane, and they may also be able to park themselves, but they are not self-driving. The semi-autonomous vehicles act independently to some degree.

As used herein, the term “degraded cells” refers to energy storage cells where the physical and chemical changes have occurred. The degraded cells can store, receive, or deliver energy less than the actual capacity.

As used herein, the term “healthy cells” refers to energy storage cells which can store, receive, or deliver energy equal to the actual capacity.

As used herein, the term “moderate degraded cells” refers to energy storage cells which can store, receive, or deliver energy less than the actual capacity but equal to a threshold capacity.

As used herein, the term “vehicle computer system” refers to an embedded system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user. The vehicle computer system may also be communicatively coupled with the other electric vehicle and connector.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construc transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to one or more embodiments described herein. In this regard, each block in the flowchart or block diagrams can represent a module, segment, and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be cither hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches, and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random-access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

In an aspect, a system is described. The system comprises: a processor storing instructions in non-transitory memory that, when executed, causes the processor to: determine a charging location and reserves a first charging schedule with a charging station at the charging location as per an actual plan; monitors an expected time-of-arrival (ETA) at the charging location and a state-of-charge of a battery pack of the vehicle in real-time; predict whether an operational plan deviates from the actual plan based on the expected time-of-arrival (ETA) and the state-of-charge; and modify the first charging schedule to a second charging schedule to comply with actual time-of-arrival and the state-of-charge.

Business problem: Electric vehicles may reserve a charging session with a charging station in advance based on expected time-of-arrival and remaining charge of battery. However, due to unforeseen circumstances there may be chances that the vehicle may have to deviate from its plan and operate in a different way. This may lead to a change in the expected time-of-arrival and/or remaining battery, such that the vehicle could not charge the vehicle as per the charging session. In such a case, the charging session has to be cancelled or rescheduled. The rescheduling or the cancellation of the charging session minimizes the efficiency or utilization of the charging infrastructure. Further the rescheduling or cancellation further creates issues in making or adjusting the advance reservations. Accordingly, there remains a need to modify the reserved charging adaptively to charge the vehicle with desired charge at the actual time of arrival.

Business Solution: The present disclosure provides a system that adaptively modifies the charging session considering the difference in the expected time-of-arrival and the actual time-of-arrival. The charging session may also be modified considering the charging level to start charging. The adaptive modification of the charging session is done based on urgency score. The urgency score is generated based on the cause for the delay in arrival at the charging location. The system may charge more cost per unit electricity to charge the vehicle as per the modified charging reservation plan. This monetary benefit creates a business gap. A “business gap” typically refers to a discrepancy or a missing element within a business that represents an opportunity for improvement, growth, or innovation. Identifying and addressing business gaps is crucial for maintaining competitiveness and achieving strategic objectives. The proposed solution identifies and addresses the business gap.

Technical problem: In a conventional reservation system, if estimated arrival time and the actual arrival time are significantly different, the re-reservation or reservation is canceled. However, there is an unfair feeling that re-reservation and the reservation itself are canceled due to the arrival time delay despite the early reservation. On the other hand, if the reservation system can flexibly change the reservation schedule according to the arrival time, not re-reservation or cancellation, the charger of the charging station can be used efficiently, and unfairness does not occur. The problem is that once a charging spot is reserved, modifying the schedule is time consuming, has no timely guarantee, and does not provide a good customer experience. Thus, an adaptive charging schedule is needed.

Technical Solution: Proposed is a system that adaptively modifies the charging reservation plan. The charging reservation plan may be booked in advance to charge the vehicle considering the expected time-of-arrival (ETA). There may be a situation that deviates from the operational plan of the vehicle which, in turn, may cause a change in remaining state-of-charge and a delay in arrival at the charging location. The system monitors the current location of the vehicle in real-time and the state-of-charge of the battery pack. The system may predict whether the vehicle could make it to the charging location at the ETA. The system then may adaptively modify the charging reservation plan with the same charging station or a different charging station as per the actual time-of-arrival and to begin charging from the charging level set. The system may also suggest a new charger, new location, driving habits, etc. to comply with the actual time-of-arrival and to begin charging from the charging level set.

In an aspect, the system determines the location for charging station (e.g., location X) and reserves a charger at a location X, at Y time and for a duration Z. The initial reservation is based on all information provided or determined based on user habits, road conditions, charge remaining, health of battery, availability of charging stations, preferred routing and location of charger (e.g., work or coffee shop). Once the charging station is reserved, the system monitors the time of arrival and remaining charge. If determined that the time of arrival or remaining charge has changed, the system adaptively modifies the charging schedule. If determined that the charging station is unavailable for a modified schedule, the system identifies a new charger, location, duration of charge, type of charge (slow, medium, fast) to maintain ETA at a set location. For example, if the user wants to arrive at a final location with a certain level of charge remaining (e.g., 40% and arriving at 9 am), the system determines the optimal charging schedule to satisfy the requirement. In the event the user is delayed, the system begins determining new scheduling to satisfy the initial requirement (e.g., arrive at 9 am with 40% charge). The system may suggest a new location to charge, driving habit modification, route changes based on traffic, and roads (hills), etc.

Technical Result: The present disclosure discloses the system that adaptively modifies a first charging reservation plan to a second charging reservation plan. The first charging reservation plan is modified to the second charging reservation plan in accordance with actual time-of-arrival a predefined state-of-charge (e.g., remaining charge). If the charging system is not available as per the second charging reservation plan, the system suggests a new charger, new location, driving behavior, etc.

How Technical Solution is a Technological Advancement: The present system eliminates the need for cancelling or rescheduling the charging reservation plan. The present system further enables utilization of the charging infrastructure efficiently. The present system further enables modification of the charging reservation plan without disturbing the other time slots reserved for charging other vehicles. The present system further enables the user to charge the vehicle as per the actual time-of-arrival without making them wait in queue.

### Technical Details Specific to the Technical Solution:

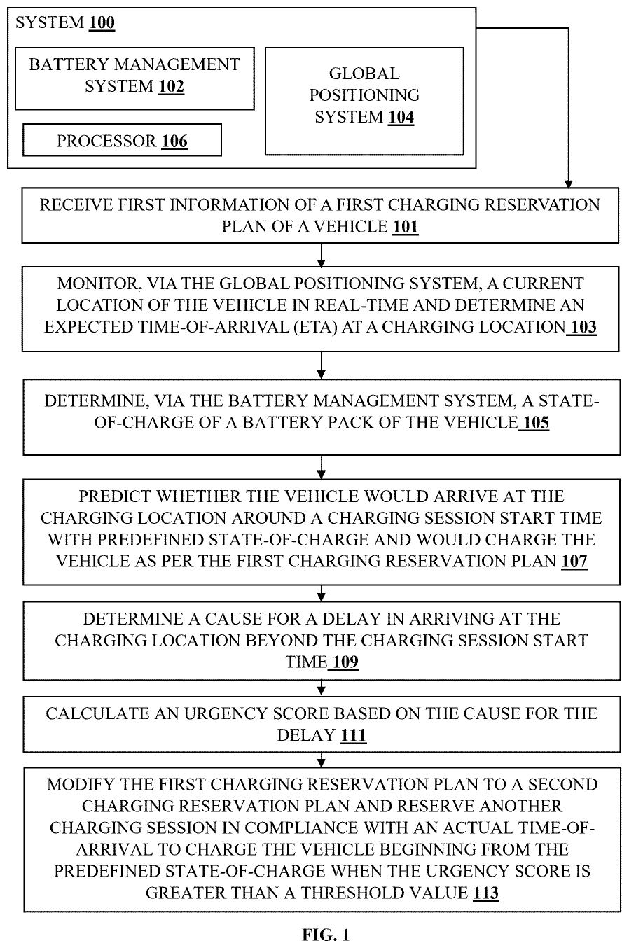

In an aspect, a system is described. As an example, FIG. 1 illustrates a system 100, according to one or more embodiments. The system 100 comprises: a battery management system 102; a global positioning system (GPS) 104; and a processor 106. The processor 106 storing instructions in non-transitory memory that, when executed, causes the processor 106 to: receive first information of a first charging reservation plan of a vehicle with a first charging station (at step 101); monitor, via the global positioning system, a current location of the vehicle in real-time and determine an expected time-of-arrival (ETA) at a charging location (at step 103); determine, via the battery management system, a state-of-charge of a battery pack of the vehicle (at step 105); predict whether the vehicle would arrive at the charging location around a charging session start time with predefined state-of-charge and would charge the vehicle as per the first charging reservation plan (at step 107); determine a cause for a delay in arriving at the charging location beyond the charging session start time (at step 109); calculate an urgency score based on the cause for the delay (at step 111); and modify the first charging reservation plan to a second charging reservation plan and reserve a second charging session with one of the first charging station and a second charging station in compliance with an actual time-of-arrival to charge the vehicle beginning from the predefined state-of-charge when the urgency score is greater than a threshold value (at step 113). The first charging reservation plan comprises the first information of a first charging session. The second charging reservation plan comprises a second information of a second charging session. In an embodiment, the first information comprises the charging location, navigation information, a charging station ID, a charging duration, the charging session start time, a charging session end time, a charging sequence, a charging temperature, a charging level to start charging, and a charging mode.

In an embodiment, the processor 106 is operable to receive the first information of the first charging reservation plan of the vehicle from at least one of an external system and an external database. In another embodiment, the processor 106 is operable to receive the first information of the first charging reservation plan of the vehicle from at least one of a charging reservation plan management server. In another embodiment, the processor 106 is operable to receive the first information of the first charging reservation plan from a vehicle computer system.

The processor 106 is operable to monitor the current location of the vehicle in real-time by tracking the movement of a user device of a user travelling in the vehicle. The processor 106 then predicts whether the vehicle would arrive at the charging location around the charging session start time. In an embodiment, the processor 106 predicting whether the vehicle would arrive at the charging location around the charging session start time comprises the following technical steps. The processor 106 is operable to extract at least one of the charging location, navigation information, a charging station ID, a charging duration, the charging session start time, a charging session end time, a charging sequence, a charging temperature, a charging level to start charging, and a charging mode from the first information of the first charging reservation plan; compare the charging session start time and the expected time-of-arrival (ETA) of the vehicle at the charging location; determine whether the charging session start time is greater than or equal to the expected time-of-arrival (ETA) of the vehicle at the charging location; and confirm that the vehicle would arrive at the charging location around the charging session start time when the charging session start time is greater than or equal to the expected time-of-arrival (ETA) of the vehicle at the charging location.

In another embodiment, the processor 106 predicting whether the vehicle would arrive at the charging location around the charging session start time comprises the following technical steps. The processor 106 is operable to extract at least one of the charging location, navigation information, a charging station ID, a charging duration, the charging session start time, a charging session end time, a charging sequence, a charging temperature, a charging level to start charging, and a charging mode from the first information of the first charging reservation plan; compare the charging session start time and the expected time-of-arrival (ETA) of the vehicle at the charging location; determine whether the charging session start time is less than (earlier than) the expected time-of-arrival (ETA) of the vehicle within a threshold limit; and confirm that the vehicle would arrive at the charging location around the charging session start time when the charging session start time is less than the expected time-of-arrival (ETA) of the vehicle within the threshold limit. The threshold limit comprises a range of about 1 to 15 minutes.

In another embodiment, the processor 106 predicting whether the vehicle would arrive at the charging location around the charging session start time comprises the following technical steps. The processor 106 is operable to calculate a distance between the current location of the vehicle and the charging location; estimate an amount of charge required to travel the distance between the current location of the vehicle and the charging location; compare the state-of-charge of the vehicle and the amount of charge required to travel the distance between the current location of the vehicle and the charging location; and determine whether the vehicle would arrive at the charging location around the charging session start time based on result of the comparison.

In an embodiment, the processor 106 estimates the amount of charge required to travel the distance between the current location of the vehicle and the charging location based on previous travel history of the vehicle in corresponding routes. The processor 106 may further estimate the amount of charge required to travel the distance between the current location of the vehicle and the charging location based on traffic conditions in real-time. The processor 106 may further estimate the amount of charge required to travel the distance between the current location of the vehicle and the charging location based on road conditions. The processor 106 may further estimate the amount of charge required to travel the distance between the current location of the vehicle and the charging location based on ambient temperature that impacts the state-of-charge of the vehicle. The processor 106 may further estimate the amount of charge required to travel the distance between the current location of the vehicle and the charging location based on state-of-health of a battery pack of the vehicle.

The processor 106 determines the cause for the delay in arriving at the charging location when the processor 106 predicts that the vehicle would not arrive at the charging location around the charging session start time. In an embodiment, the processor 106 determines the cause for the delay in arriving at the charging location based on travel path information. The travel path information comprises at least a start point, an end point, one or more intermediary points, a navigation route, a halt period, a traffic condition, an environmental weather condition, and a road condition. The processor 106 may determine the cause for the delay as one of intentional delay and unintentional delay based on the travel path information. In one embodiment, the processor 106 communicates with a sensor module and determines the cause for the delay is due to the environmental weather condition based on a signal received from the sensor module. The sensor module may sense a driving behavior of a user and the environmental weather condition and communicate the signals to the processor. The processor determines the cause for the delay as unintentional delay when the cause for the delay is due to the environmental weather condition.

The processor 106 calculates the urgency score as high when the cause for the delay is the unintentional delay. In an embodiment, the processor 106 calculates the urgency score as low when the cause for the delay is the intentional delay. In an embodiment, the processor 106 is operable to modify the first charging reservation plan to the second charging reservation plan with the first charging station in compliance with the actual time-of-arrival when the urgency score is greater than the threshold value. In another embodiment, the processor 106 is operable to modify the first charging reservation plan to the second charging reservation plan with the second charging station in compliance with the actual time-of-arrival when the urgency score is less than the threshold value. In another embodiment, the processor 106 is operable to modify the first charging reservation plan to the second charging reservation plan with the second charging station in an anticipated route of the vehicle in compliance with the actual time-of-arrival when the urgency score is less than the threshold value.

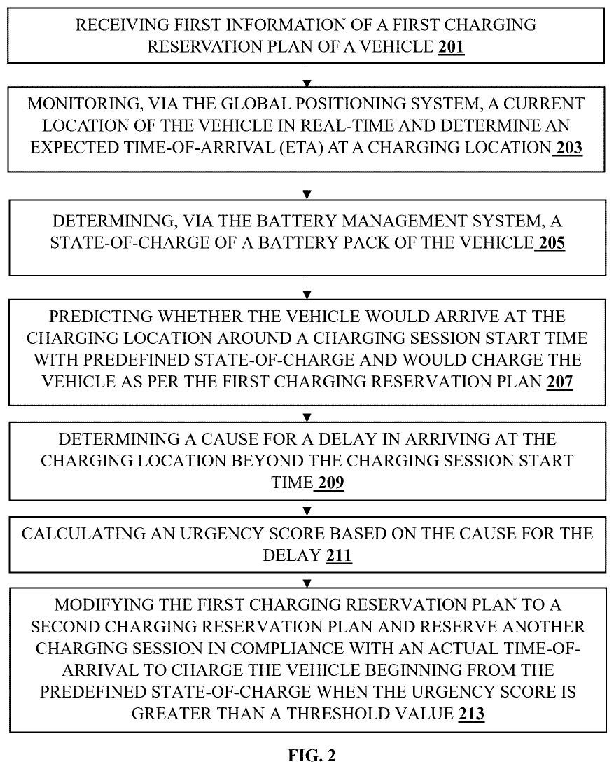

In an aspect, a method is described. As an example, FIG. 2 illustrates a method, according to one or more embodiments. The method comprises the technical steps as follows: receiving first information of a first charging reservation plan of a vehicle with a first charging station (at step 201); monitoring, via a global positioning system, a current location of the vehicle in real-time and determine an expected time-of-arrival (ETA) at a charging location (at step 203); determining, via a battery management system, a state-of-charge of a battery pack of the vehicle (at step 205); predicting whether the vehicle would arrive at the charging location around a charging session start time with predefined state-of-charge and would charge the vehicle as per the first charging reservation plan (at step 207); determining a cause for a delay in arriving at the charging location beyond the charging session start time (at step 209); calculating an urgency score based on the cause for the delay (at step 211); and modifying the first charging reservation plan to a second charging reservation plan and reserve a second charging session with one of the first charging station and a second charging station in compliance with an actual time-of-arrival to charge the vehicle beginning from the predefined state-of-charge when the urgency score is greater than a threshold value (at step 213). In an embodiment, the first information comprises the charging location, navigation information, a charging station ID, a charging duration, the charging session start time, a charging session end time, a charging sequence, a charging temperature, a charging level to start charging, and a charging mode. The first charging reservation plan comprises the first information of a first charging session. The second charging reservation plan comprises second information of a second charging session.

In an embodiment, the method further comprises: receiving the first information of the first charging reservation plan of the vehicle from at least one of an external system and an external database. In another embodiment, the method further comprises: receiving the first information of the first charging reservation plan of the vehicle from at least one of a charging reservation plan management server. In another embodiment, the method further comprises: receiving the first information of the first charging reservation plan from a vehicle computer system.

The method further comprises: monitoring the current location of the vehicle in real-time by tracking movement of a user device of a user travelling in the vehicle; and predicting whether the vehicle would arrive at the charging location around the charging session start time.

In an embodiment, the technical step of predicting whether the vehicle would arrive at the charging location around the charging session start time further comprises: extract at least one of the charging location, navigation information, a charging station ID, a charging duration, the charging session start time, a charging session end time, a charging sequence, a charging temperature, a charging level to start charging, and a charging mode from the first information of the first charging reservation plan; compare the charging session start time and the expected time-of-arrival (ETA) of the vehicle at the charging location; determine whether the charging session start time is greater than or equal to the expected time-of-arrival (ETA) of the vehicle at the charging location; and confirm that the vehicle would arrive at the charging location around the charging session start time when the charging session start time is greater than or equal to the expected time-of-arrival (ETA) of the vehicle at the charging location.

In another embodiment, the technical step of predicting whether the vehicle would arrive at the charging location around the charging session start time further comprises: extract at least one of the charging location, navigation information, a charging station ID, a charging duration, the charging session start time, a charging session end time, a charging sequence, a charging temperature, a charging level to start charging, and a charging mode from the first information of the first charging reservation plan; compare the charging session start time and the expected time-of-arrival (ETA) of the vehicle at the charging location; determine whether the charging session start time is less than the expected time-of-arrival (ETA) of the vehicle within a threshold limit; and confirm that the vehicle would arrive at the charging location around the charging session start time when the charging session start time is less than the expected time-of-arrival (ETA) of the vehicle within the threshold limit. The threshold limit comprises a range of about 1 to 15 minutes.

In another embodiment, the technical step of predicting whether the vehicle would arrive at the charging location around the charging session start time further comprises: calculate a distance between the current location of the vehicle and the charging location; estimate an amount of charge required to travel the distance between the current location of the vehicle and the charging location; compare the state-of-charge of the vehicle and the amount of charge required to travel the distance between the current location of the vehicle and the charging location; and determine whether the vehicle would arrive at the charging location around the charging session start time based on the result of the comparison.

The method further comprises: estimating the amount of charge required to travel the distance between the current location of the vehicle and the charging location based on previous travel history of the vehicle in corresponding routes. The method further comprises: estimating the amount of charge required to travel the distance between the current location of the vehicle and the charging location based on traffic conditions in real-time. The method further comprises: estimating the amount of charge required to travel the distance between the current location of the vehicle and the charging location based on road conditions. The method further comprises: estimating the amount of charge required to travel the distance between the current location of the vehicle and the charging location based on ambient temperature that impacts the state-of-charge of the vehicle. The method further comprises: estimating the amount of charge required to travel the distance between the current location of the vehicle and the charging location based on state-of-health of a battery pack of the vehicle.

In an embodiment, the method further comprises: determining the cause for the delay in arriving at the charging location based on travel path information. The travel path information comprises at least a start point, an end point, one or more intermediary points, a navigation route, a halt period, a traffic condition, an environmental weather condition, and a road condition.

The method further comprises: determining the cause for the delay as one of intentional delay and unintentional delay based on the travel path information. In an embodiment, the method further comprises: communicating with a sensor module and determining the cause for the delay is due to the environmental weather condition based on a signal received from the sensor module. The method further comprises: sensing, by the sensor module, a driving behavior of a user and the environmental weather condition and communicating the signal to a processor. The method further comprises: determining the cause for the delay as unintentional delay when determining the cause is due to the environmental weather condition.

The method further comprises: calculating the urgency score as high when the cause for the delay is the unintentional delay. The method further comprises: calculating the urgency score as low when the cause for the delay is the intentional delay. In an embodiment, the method further comprises: modifying the first charging reservation plan to the second charging reservation plan with the first charging station in compliance with the actual time-of-arrival when the urgency score is greater than the threshold value. In another embodiment, the method further comprises: modifying the first charging reservation plan to the second charging reservation plan with the second charging station in compliance with the actual time-of-arrival when the urgency score is lesser than the threshold value. In another embodiment, the method further comprises: modifying the first charging reservation plan to the second charging reservation plan with the second charging station in an anticipated route of the vehicle in compliance with the actual time-of-arrival when the urgency score is lesser than the threshold value.

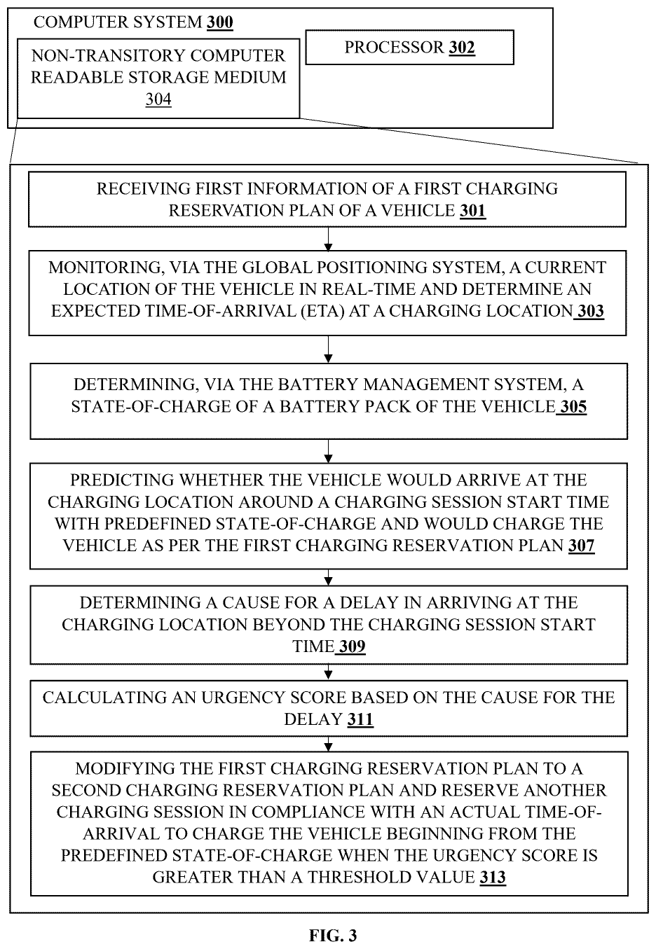

In an aspect, a non-transitory computer readable storage medium 304 is described. As an example, FIG. 3 illustrates a non-transitory computer readable storage medium 304, according to one or more embodiments. The non-transitory computer readable storage medium 304 comprising a sequence of instructions which when executed by a processor 302 causes: receiving first information of a first charging reservation plan of a vehicle with a first charging station (at step 301); monitoring, via a global positioning system, a current location of the vehicle in real-time and determine an expected time-of-arrival (ETA) at a charging location (at step 303); determining, via a battery management system, a state-of-charge of a battery pack of the vehicle (at step 305); predicting whether the vehicle would arrive at the charging location around a charging session start time with predefined state-of-charge and would charge the vehicle as per the first charging reservation plan (at step 307); determining a cause for a delay in arriving at the charging location beyond the charging session start time (at step 309); calculating an urgency score based on the cause for the delay (at step 311); and modifying the first charging reservation plan to a second charging reservation plan and reserve a second charging session with one of the first charging station and a second charging station in compliance with an actual time-of-arrival to charge the vehicle beginning from the predefined state-of-charge when the urgency score is greater than a threshold value (at step 313). The computer system 300 comprising the non-transitory computer readable storage medium 304 storing a sequence of instructions which when executed by the processor 302 causes to execute the above mentioned technical steps.

The first information comprises the charging location, navigation information, a charging station ID, a charging duration, the charging session start time, a charging session end time, a charging sequence, a charging temperature, a charging level to start charging, and a charging mode. The first charging reservation plan comprises the first information of a first charging session. The second charging reservation plan comprises second information of a second charging session.

In an embodiment, the non-transitory computer readable storage medium further causes: receiving the first information of the first charging reservation plan of the vehicle from at least one of an external system and an external database. In another embodiment, the non-transitory computer readable storage medium further causes: receiving the first information of the first charging reservation plan of the vehicle from at least one of a charging reservation plan management server. In another embodiment, the non-transitory computer readable storage medium further causes: receiving the first information of the first charging reservation plan from a vehicle computer system.

In an embodiment, the non-transitory computer readable storage medium further causes: monitoring the current location of the vehicle in real-time by tracking movement of a user device of a user travelling in the vehicle; and predicting whether the vehicle would arrive at the charging location around the charging session start time.

In an embodiment, predicting whether the vehicle would arrive at the charging location around the charging session start time further causes: extract at least one of the charging location, navigation information, a charging station ID, a charging duration, the charging session start time, a charging session end time, a charging sequence, a charging temperature, a charging level to start charging, and a charging mode from the first information of the first charging reservation plan; compare the charging session start time and the expected time-of-arrival (ETA) of the vehicle at the charging location; determine whether the charging session start time is greater than (later than) or equal to the expected time-of-arrival (ETA) of the vehicle at the charging location; and confirm that the vehicle would arrive at the charging location around the charging session start time when the charging session start time is greater than or equal to the expected time-of-arrival (ETA) of the vehicle at the charging location.

In another embodiment, predicting whether the vehicle would arrive at the charging location around the charging session start time further causes: extract at least one of the charging location, navigation information, a charging station ID, a charging duration, the charging session start time, a charging session end time, a charging sequence, a charging temperature, a charging level to start charging, and a charging mode from the first information of the first charging reservation plan; compare the charging session start time and the expected time-of-arrival (ETA) of the vehicle at the charging location; determine whether the charging session start time is less than (earlier than) the expected time-of-arrival (ETA) of the vehicle within a threshold limit; and confirm that the vehicle would arrive at the charging location around the charging session start time when the charging session start time is less than (earlier than) the expected time-of-arrival (ETA) of the vehicle within the threshold limit. The threshold limit comprises a range of about 1 to 15 minutes.

In another embodiment, predicting whether the vehicle would arrive at the charging location around the charging session start time further causes the processor to: calculate a distance between the current location of the vehicle and the charging location; estimate an amount of charge required to travel the distance between the current location of the vehicle and the charging location; compare the state-of-charge of the vehicle and the amount of charge required to travel the distance between the current location of the vehicle and the charging location; and determine whether the vehicle would arrive at the charging location around the charging session start time based on result of the comparison.

In an embodiment, the non-transitory computer readable storage medium further causes: estimating the amount of charge required to travel the distance between the current location of the vehicle and the charging location based on previous travel history of the vehicle in corresponding routes. In another embodiment, the non-transitory computer readable storage medium further causes: estimating the amount of charge required to travel the distance between the current location of the vehicle and the charging location based on traffic conditions in real-time. In another embodiment, the non-transitory computer readable storage medium further causes: estimating the amount of charge required to travel the distance between the current location of the vehicle and the charging location based on road conditions. In another embodiment, the non-transitory computer readable storage medium further causes: estimating the amount of charge required to travel the distance between the current location of the vehicle and the charging location based on ambient temperature that impacts the state-of-charge of the vehicle. In another embodiment, the non-transitory computer readable storage medium further causes: estimating the amount of charge required to travel the distance between the current location of the vehicle and the charging location based on state-of-health of a battery pack of the vehicle.

The non-transitory computer readable storage medium further causes: determining the cause for the delay in arriving at the charging location based on travel path information. The travel path information comprises at least a start point, an end point, one or more intermediary points, a navigation route, a halt period, a traffic condition, an environmental weather condition, and a road condition. The non-transitory computer readable storage medium further causes: determining the cause for the delay as one of intentional delay and unintentional delay based on the travel path information. In an embodiment, the non-transitory computer readable storage medium further causes: communicating with a sensor module and determining the cause for the delay is due to the environmental weather condition based on a signal received from the sensor module. In an embodiment, the non-transitory computer readable storage medium further causes: sensing, by the sensor module, a driving behavior of a user and the environmental weather condition and communicating the signal to a processor. In an embodiment, the non-transitory computer readable storage medium further causes: determining the cause for the delay as unintentional delay when the cause for the delay is due to the environmental weather condition.

In an embodiment, the non-transitory computer readable storage medium further causes: calculating the urgency score as high when the cause for the delay is the unintentional delay. In another embodiment, the non-transitory computer readable storage medium further causes: calculating the urgency score as low when the cause for the delay is the intentional delay.

In an embodiment, the non-transitory computer readable storage medium further causes: modifying the first charging reservation plan to the second charging reservation plan with the first charging station in compliance with the actual time-of-arrival when the urgency score is greater than the threshold value. In another embodiment, the non-transitory computer readable storage medium further causes: modifying the first charging reservation plan to the second charging reservation plan with the second charging station in compliance with the actual time-of-arrival when the urgency score is lesser than the threshold value. In another embodiment, the non-transitory computer readable storage medium further causes: modifying the first charging reservation plan to the second charging reservation plan with the second charging station in an anticipated route of the vehicle in compliance with the actual time-of-arrival when the urgency score is lesser than the threshold value.

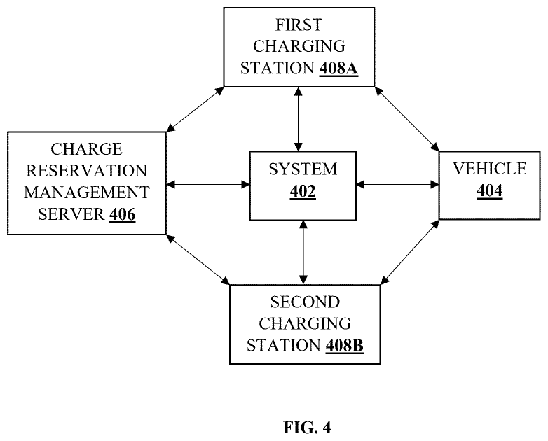

As an example, FIG. 4 illustrates a schematic diagram illustrating a technical idea of adaptive charging scheduling, according to one or more embodiments. The schematic diagram shown in FIG. 4 depicts a system 402, a vehicle 404, a charge reservation management server 406 and one or more charging stations. The one or more charging stations comprises a first charging station 408A, a second charging station 408B, etc. The system 402 comprises a battery management system (BMS), a global positioning system (GPS), and a processor. The system 402 is communicatively coupled to the vehicle 404 and the charge reservation management server 406. The system 402 extracts the first charging reservation plan from one of the vehicle 404 and the charge reservation management server 406.

The system 402 is also communicatively coupled to the one or more charging stations. The system 402 adaptively modifies the first charging reservation plan to the second charging reservation plan in compliance with the actual time-of-arrival and the state-of-charge. The system 402 communicates with the one or more charging stations to modify the first charging session to the second charging session and schedules the second charging session as per the second charging reservation plan. According to this embodiment, the system 402 resides away from the vehicle 404. The system 402 may be a server that resides in the cloud or other premises.

As an example, FIG. 5 illustrates a schematic diagram illustrating a technical idea of adaptive charging scheduling, according to one or more embodiments. The schematic diagram shown in FIG. 5 depicts a vehicle 502, a charge reservation management server 506 and one or more charging stations. The vehicle 502 comprises a system 504. The one or more charging stations comprises a first charging station 508A, a second charging station 508B, etc. The vehicle 502 comprises a battery management system (BMS), a vehicle computer system and a global positioning system (GPS). The system 504 comprises a processor. The system 504 is communicatively coupled to the vehicle computer system and the charge reservation management server 506. The system 504 extracts the first charging reservation plan from one of the vehicle computer system and the charge reservation management server 506.

The system 504 is also communicatively coupled to the one or more charging stations. The system 504 adaptively modifies the first charging reservation plan to the second charging reservation plan in compliance with the actual time-of-arrival and the state-of-charge. The system 504 communicates with the one or more charging stations to modify the first charging session to the second charging session and schedules the second charging session as per the second charging reservation plan. According to this embodiment, the system 504 resides within the vehicle 502.

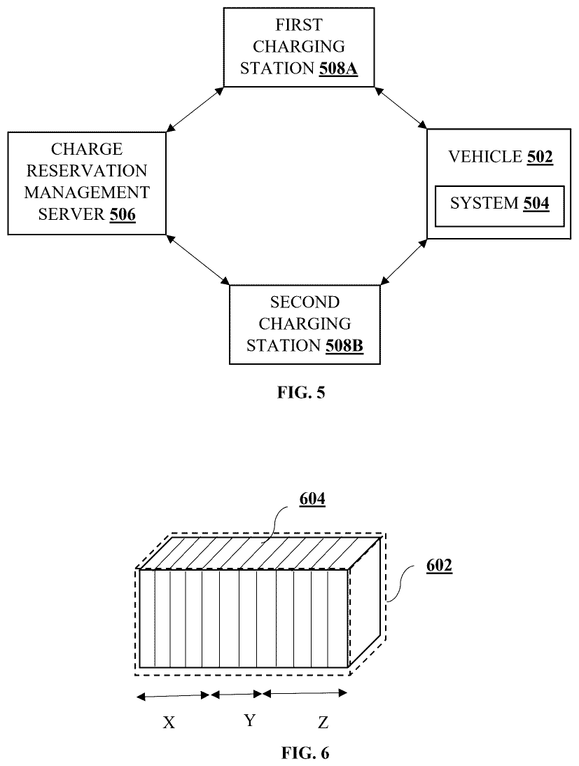

As an example, FIG. 6 illustrates a battery pack 602 comprising an individual battery, according to one or more embodiments. The battery pack 602 herein comprises an individual battery. The battery comprises a plurality of cells 604. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state-of-health information at the respective portions. The first portion X may comprise a first state-of-health information. The second portion Y may comprise a second state-of-health information. The third portion Z may comprise a third state-of-health information. In an embodiment, the first portion may refer to a portion of the battery having degraded cells. The second portion may refer to a portion of the battery having healthy cells. The third portion may refer to a portion of the battery having moderate degraded cells.

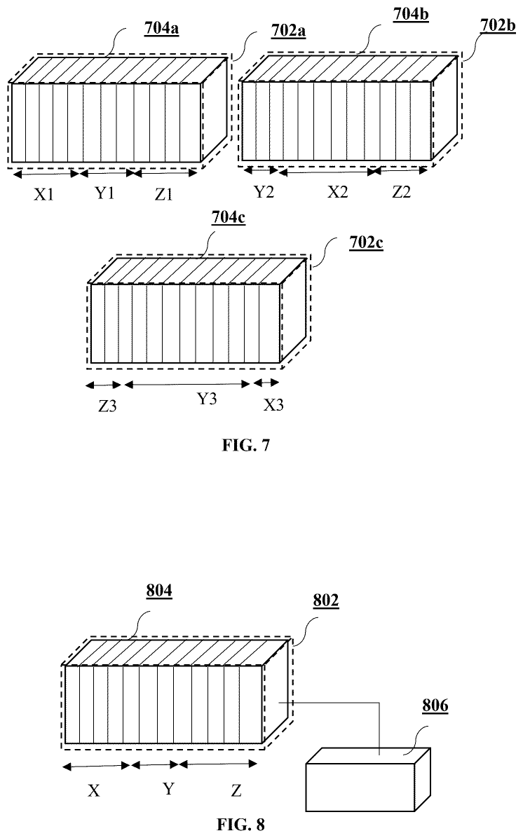

As an example, FIG. 7 illustrates a battery pack comprising a plurality of batteries, according to one or more embodiments. The battery pack herein comprises a first battery 702a, a second battery 702b, and a third battery 702c. The first battery 702a, the second battery 702b, and the third battery 702c may be identical batteries. The first battery 702a, the second battery 702b, and the third battery 702c may be non-identical batteries. In an embodiment, each battery of the battery pack may comprise equal capacity to store and deliver power. In another embodiment, each battery of the battery pack may comprise a different capacity to store and deliver power.

The first battery 702a may comprise a plurality of first cells 704a. The second battery 702b may comprise a plurality of second cells 704b. The third battery 702c may comprise a plurality of third cells 704c. Each battery of the battery pack is connected electrically to get charged by the charging station. The charging station may charge the batteries of the battery pack in a serial configuration, a parallel configuration, or individually.

The charging station may charge at least one of a first portion X, a second portion Y, and a third portion Z of the battery pack. The first portion X of the battery pack refers to degraded cells from each battery of the battery pack (X=X1+X2+X3). The second portion Y of the battery pack refers to healthy cells from each battery of the battery pack (Y=Y1+Y2+Y3). The third portion Z of the battery pack refers to moderate degraded cells from each battery of the battery pack (Z=Z1+Z2+Z3). Healthy cells may be contiguously or non-contiguously located within the same battery. Similarly, degraded, and moderate degraded cells may be contiguously or non-contiguously located within the same battery.

The charging station is configured to map the battery pack based on the state-of-health information. In an embodiment, the charging station maps at least one of the degraded cells, the healthy cells, and the moderate degraded cells of the battery pack. The charging station, upon performing mapping the battery pack, determines the charging sequence based on the state-of-health information and the charging time. The charging station may assign the charging sequence to particular portions of the battery pack. In an embodiment, the charging station assigns the charging sequence to only the healthy cells and the moderate degraded cells of the battery pack. The charging station may ignore charging the degraded cells.

As an example, FIG. 8 schematically shows a battery pack comprising a battery pack 802 and a battery management system 806, according to one or more embodiments. The battery pack 802 comprises a plurality of cells 804. The battery management system 806 may include a microprocessor, microcontroller unit, programmable digital signal processor, or another programmable device. The battery management system 806 may also, or alternatively, comprise an application specific integrated circuit, a programmable gate array or programmable array logic, a programmable logic device or a digital signal processor. Where the battery management system 806 comprises a programmable device such as the microprocessor, microcontroller unit or programmable digital signal processor mentioned above, the processor may also comprise computer executable code which controls the operation of the programmable device. In an embodiment, the battery management system 806 resides within an electric vehicle. The battery management system 806 determines the state-of-health (SoH) of the battery pack and communicates to the charging station via a vehicle computer system.

In an embodiment, the battery management system 806 is configured to: measure a first battery property and a battery temperature of a battery in the electric vehicle; calculating the state-of-health (SoH) of the battery or the determined battery attributes using a predetermined modelcale (ii) providing a function f for estimating the cell degradation rate; updating the state-of-health estimated in the previous time step according to:

$$S o {H}_{est} ← S o {H}_{est} + f \cdot dt + K \cdot ( S o {H}_{calc} - S o {H}_{est} )$$

where K is a gain factor that depends on the operating conditions of the vehicle, and where a reinforcement learning agent modifies K for each time step.

In another embodiment, the battery management system 806 estimates State-of-health (SoH) characteristics of a battery pack in a hybrid vehicle. The estimation of the SoH includes: charging and discharging the battery pack at least one time within an upper region of a State-of-charge (SOC) window. In this case, the battery pack is charged to a first predetermined level in the upper region of the SOC window during a first time period. A first charge current impulse, then charge the battery pack for pushing the SOC level of the battery pack to a level above the first predetermined level and outside the SOC window, during a second time period. An electrical machine then discharges the battery pack to a second predetermined level within the SOC window.

The estimation of the SoH further includes: charging and discharging the battery pack at least one time within a lower region of the SOC window. In this case, the battery pack is charged to a third predetermined level in the SOC window, during a third time period. The battery pack is then discharged by an electrical machine to a fourth predetermined level in the SOC window. A second current impulse, then discharges the battery pack, for pushing the SOC level of the battery pack to a level below the fourth predetermined level and below the SOC window, during a fourth time period.

The estimation of the SoH further includes: calibrating a vehicle's battery pack by the battery management system 806 comprised in the hybrid vehicle by using the reached levels outside the SOC window for determining correct upper and lower edges of the current soc window; and estimating the SoH characteristics of the battery pack during the charge and discharge periods by using the battery management system 806 for determining the condition of the battery pack in comparison to a new and unused battery pack by comparing the current SOC window with a standard SOC window. In an embodiment, the first and third time period is longer than the second and fourth time period, respectively. In another embodiment, the first predetermined level represents a higher voltage than the second predetermined level, and the third predetermined level represents a higher voltage than the fourth predetermined level.

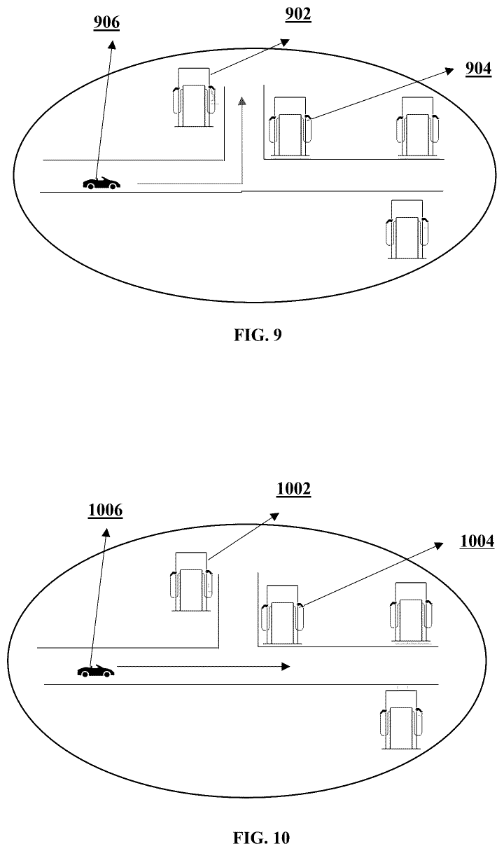

As an example, FIG. 9 illustrates a vehicle approaching for charging as per the first charging reservation plan, according to one or more embodiments. The vehicle 906 may travel from location A (e.g., workplace) to location B (e.g., home) on a daily basis at a certain time (e.g., 7 PM to 8 PM). The vehicle 906 may have booked the first charging session (e.g., 7.30 PM to 8 PM) with the first charging station 902 as per the routine. The vehicle 906 may then reach the first charging station 902 at the charging location and gets charged as per the first charging reservation plan.

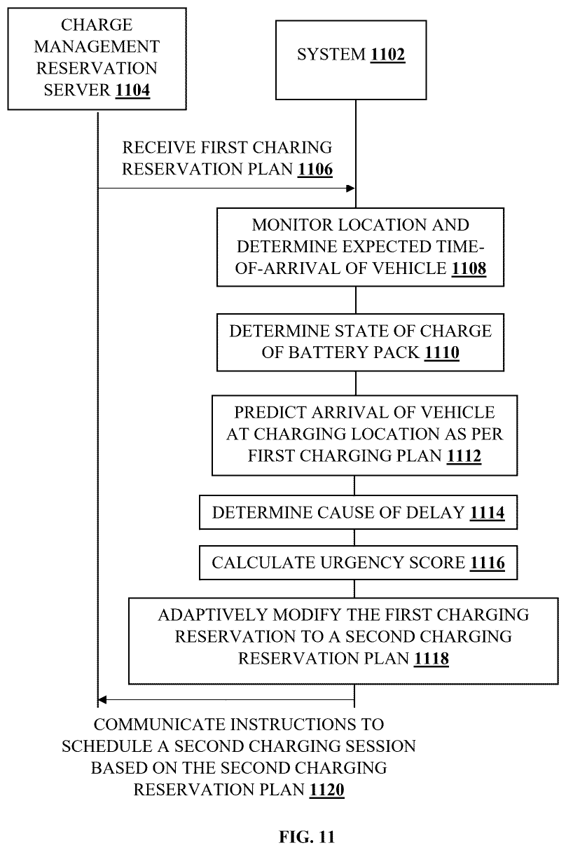

The system does not modify the first charging session unless there is a delay in the arrival of the vehicle 906 at the charging location. The system may monitor the location of the vehicle 906 in real-time from a predefined time prior to the charging session start time. For example, the system may monitor the current location of the vehicle 906 from 7.15 PM (i.e., 15 minutes prior to charging session start time i.e., 7.30 PM). The system then determines the expected time-of-arrival of the vehicle 906 at the charging location. If the expected time-of-arrival of the vehicle 906 is significantly greater than the charging session start time, the system may adaptively modify the first charging reservation plan to the second charging reservation plan with the second charging station 904 to comply with the actual time-of-arrival and the state-of-charge (as described below in FIG. 10).

As an example, FIG. 10 illustrates a vehicle approaching for charging as per the second charging reservation plan, according to one or more embodiments. The vehicle 1006 may have initially reserved a first charging session with the first charging station 1002 considering the expected time-of-arrival. The itinerary of the vehicle 1006 may have changed due to some unforeseen circumstances on the scheduled date and the vehicle 1006 may be expected to arrive at the charging location beyond the expected time-of-arrival. The system monitors the location of the vehicle 1006 in real-time and determines an event or an activity that depicts the deviation of the operational plan from the actual plan. For example, the vehicle 1006 may travel in the route or in a direction different from the actual scheduled plan path. The system monitors the movement of the vehicle 1006. The system, upon detecting the change, may automatically modify the first charging reservation plan to the second charging reservation plan.

The system may automatically schedule a second charging session based on the second charging reservation plan. The system may schedule the second charging session with the second charging station 1004. In this case, the second charging session may comprise the change in the charge duration for the second charging station 1004. The second charging station 1004 may be located close to the vehicle 1006 along the anticipated route. The second charging session complies with the actual time-of-arrival and the state-of-charge. In another embodiment, the system may schedule the second charging session with the first charging station 1002 having a different charging session start time and/or charging session end time.

As an example, FIG. 11 illustrates a communication flow diagram between a system 1102 and a charge management reservation server 1104, according to one or more embodiments. At step 1106, the system 1102 receives the first charging reservation plan from the charge management reservation server 1104. At step 1108, the system 1102 monitors the location of the vehicle in real-time and determines an expected time-of-arrival at the charging location. At step 1110, the system 1102 determines the state-of-charge of the battery back using the battery management system. At step 1112, the system 1102 predicts whether the vehicle would arrive at the charging location as per the first charging reservation plan. At step 1114, the system 1102 determines the cause of delay if the vehicle would arrive at the charging location beyond the charging session start time. At step 1116, the system 1102 calculates the urgency score based on the cause of delay. At step 1118, the system 1102 modifies the first charging reservation to a second charging reservation plan based on the urgency score. At step 1120, the system 1102 communicates instructions to the charge management reservation server 1104 to schedule the second charging session based on the second charging reservation plan.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings, such terms are intended to be inclusive in a manner similar to the term “comprising”, as “comprising” is interpreted when employed as a transitional word in a claim.

Other specific forms may embody the present invention without departing from its spirit or characteristics. The described embodiments are in all respects illustrative and not restrictive. Therefore, the appended claims, rather than the description herein, indicate the scope of the invention. All variations which come within the meaning and range of equivalency of the claims are within their scope.

1-85. (canceled)

86. A system comprising:
a battery management system (BMS);
a global positioning system (GPS); and
a processor storing instructions in non-transitory memory that, when executed, causes the processor to:
receive first information of a first charging reservation plan of a vehicle with a first charging station;
monitor, via the global positioning system, a current location of the vehicle in real-time and determine an expected time-of-arrival (ETA) at a charging location;
determine, via the battery management system, a state-of-charge of a battery pack of the vehicle;
predict whether the vehicle would arrive at the charging location around a charging session start time with predefined state-of-charge and would charge the vehicle as per the first charging reservation plan;
determine a cause for a delay in arriving at the charging location beyond the charging session start time;
calculate an urgency score based on the cause for the delay; and
modify the first charging reservation plan to a second charging reservation plan and reserve a second charging session with one of the first charging station and a second charging station in compliance with an actual time-of-arrival (ETA) to charge the vehicle beginning from the predefined state-of-charge when the urgency score is greater than a threshold value.

87. The system of claim 86, wherein the processor predicting whether the vehicle would arrive at the charging location around the charging session start time comprises:
extract at least one of the charging location, navigation information, a charging station ID, a charging duration, the charging session start time, a charging session end time, a charging sequence, a charging temperature, a charging level to start charging, and a charging mode from the first information of the first charging reservation plan;
compare the charging session start time and the expected time-of-arrival (ETA) of the vehicle at the charging location;
determine whether the charging session start time is greater than or equal to the expected time-of-arrival (ETA) of the vehicle at the charging location; and
confirm that the vehicle would arrive at the charging location around the charging session start time when the charging session start time is greater than or equal to the expected time-of-arrival (ETA) of the vehicle at the charging location.

88. The system of claim 86, wherein the processor predicting whether the vehicle would arrive at the charging location around the charging session start time further comprises:
extract at least one of the charging location, navigation information, a charging station ID, a charging duration, the charging session start time, a charging session end time, a charging sequence, a charging temperature, a charging level to start charging, and a charging mode from the first information of the first charging reservation plan;
compare the charging session start time and the expected time-of-arrival (ETA) of the vehicle at the charging location;
determine whether the charging session start time is less than the expected time-of-arrival (ETA) of the vehicle within a threshold limit; and
confirm that the vehicle would arrive at the charging location around the charging session start time when the charging session start time is less than the expected time-of-arrival (ETA) of the vehicle within the threshold limit.

89. The system of claim 88, wherein the threshold limit comprises a range of about 1 to 15 minutes.

90. The system of claim 86, wherein the processor predicting whether the vehicle would arrive at the charging location around the charging session start time comprises:
calculate a distance between the current location of the vehicle and the charging location;
estimate an amount of charge required to travel the distance between the current location of the vehicle and the charging location;
compare the state-of-charge of the vehicle and the amount of charge required to travel the distance between the current location of the vehicle and the charging location; and
determine whether the vehicle would arrive at the charging location around the charging session start time based on result of the comparison.

91. The system of claim 90, wherein the processor estimates the amount of charge required to travel the distance between the current location of the vehicle and the charging location based on previous travel history of the vehicle in corresponding routes.

92. The system of claim 91, wherein the processor further estimates the amount of charge required to travel the distance between the current location of the vehicle and the charging location based on traffic condition in real-time.

93. The system of claim 92, wherein the processor further estimates the amount of charge required to travel the distance between the current location of the vehicle and the charging location based on road conditions.

94. The system of claim 93, wherein the processor further estimates the amount of charge required to travel the distance between the current location of the vehicle and the charging location based on ambient temperature that impacts the state-of-charge of the vehicle.

95. The system of claim 94, wherein the processor further estimates the amount of charge required to travel the distance between the current location of the vehicle and the charging location based on a state-of-health of a battery pack of the vehicle.

96. A method comprising:
receiving first information of a first charging reservation plan of a vehicle with a first charging station;
monitoring, via a global positioning system, a current location of the vehicle in real-time and determine an expected time-of-arrival (ETA) at a charging location;
determining, via a battery management system, a state-of-charge of a battery pack of the vehicle;
predicting whether the vehicle would arrive at the charging location around a charging session start time with predefined state-of-charge and would charge the vehicle as per the first charging reservation plan;
determining a cause for a delay in arriving at the charging location beyond the charging session start time;
calculating an urgency score based on the cause for the delay; and
modifying the first charging reservation plan to a second charging reservation plan and reserve a second charging session with one of the first charging station and a second charging station in compliance with an actual time-of-arrival (ETA) to charge the vehicle beginning from the predefined state-of-charge when the urgency score is greater than a threshold value.

97. The method of claim 96, wherein the method further comprises: determining the cause for the delay in arriving at the charging location based on travel path information.

98. The method of claim 97, wherein the travel path information comprises at least a start point, an end point, one or more intermediary points, a navigation route, a halt period, a traffic condition, an environmental weather condition, and a road condition.

99. The method of claim 97, wherein the method further comprises: determining the cause for the delay as one of intentional delay and unintentional delay based on the travel path information.

100. The method of claim 98, wherein the method further comprises: communicating with a sensor module and determining the cause for the delay is due to the environmental weather condition based on a signal received from the sensor module.

101. The method of claim 100, wherein the method further comprises: sensing, by the sensor module, a driving behavior of a user and the environmental weather condition and communicates the signal to a processor.

102. The method of claim 99, wherein the method further comprises:
calculating the urgency score as high when the cause for the delay is the unintentional delay; and
calculating the urgency score as low when the cause for the delay is the intentional delay.

103. A non-transitory computer readable storage medium comprising a sequence of instructions which when executed by a processor causes:
receiving first information of a first charging reservation plan of a vehicle with a first charging station;
monitoring, via a global positioning system, a current location of the vehicle in real-time and determine an expected time-of-arrival (ETA) at a charging location;
determining, via a battery management system, a state-of-charge of a battery pack of the vehicle;
predicting whether the vehicle would arrive at the charging location around a charging session start time with predefined state-of-charge and would charge the vehicle as per the first charging reservation plan;
determining a cause for a delay in arriving at the charging location beyond the charging session start time;
calculating an urgency score based on the cause for the delay; and
modifying the first charging reservation plan to a second charging reservation plan and reserve a second charging session with one of the first charging station and a second charging station in compliance with an actual time-of-arrival (ETA) to charge the vehicle beginning from the predefined state-of-charge when the urgency score is greater than a threshold value.

104. The non-transitory computer readable storage medium of claim 103, further causes: modifying the first charging reservation plan to the second charging reservation plan with the first charging station in compliance with the actual time-of-arrival when the urgency score is greater than the threshold value.

105. The non-transitory computer readable storage medium of claim 103, further causes: modifying the first charging reservation plan to the second charging reservation plan with the second charging station in compliance with the actual time-of-arrival when the urgency score is lesser than the threshold value.
